(19) United States
(12) Patent Application Publication
(10) Pub. No.: US 2018/0096143 A1
(43) Pub. Date: Apr. 5, 2018

(54) SECURE CHANGE LOG FOR DRIVE ANALYSIS

(71) Applicants: Li Xiaoning, Santa Clara, CA (US); Ravi L. Sahita, Beaverton, OR (US); Benjamin W. Boyer, Hillsboro, OR (US); Sanjeev N. Trika, Portland, OR (US)

(72) Inventors: Li Xiaoning, Santa Clara, CA (US); Ravi L. Sahita, Beaverton, OR (US); Benjamin W. Boyer, Hillsboro, OR (US); Sanjeev N. Trika, Portland, OR (US)

(21) Appl. No.: 15/282,471

(22) Filed: Sep. 30, 2016

(51) Int. Cl. G06F 21/56; G06F 21/55; G06F 3/06; G06F 21/44

(52) U.S. Cl. CPC G06F 21/561; G06F 21/556; G06F 3/062; G06F 2221/033; G06F 3/0653; G06F 3/0679; G06F 21/44; G06F 3/0623

(57) ABSTRACT

According to some embodiments an electronic processing system may include a processor, memory coupled to the processor, and security code stored on the memory which when executed by the processor is to provide a trusted execution environment. A storage system may be coupled to the processor from outside of the trusted execution environment. The storage system may include a persistent storage media, a storage controller coupled to the persistent storage media, operating system code stored on the persistent storage media which when executed by the processor is to manage a file system for the electronic processing system, and storage controller code stored on the persistent storage media which when executed by the storage controller is to provide a transport layer between the file system and the persistent storage media. A sideband interface may be coupled between the storage system and the trusted execution environment bypassing the transport layer and the file system.

### TECHNICAL FIELD

Embodiments generally relate to storage systems.

### BACKGROUND

Malware may utilize rootkit capability to hide malicious components existing in persistent storage to avoid detection from security software. For example, the computer worm “Stuxnet” may have utilized a rootkit driver to protect malicious code stored in persistent storage. Security software may rely on operating system (OS) functions to detect compromised drive changes, and/or may periodically scan the OS file system to check for malware.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a storage system according to an embodiment;

FIGS. 2A to 2D are flow diagrams an example of a method of controlling a storage system according to embodiments;

FIG. 3 is a block diagram of an example of an electronic processing system according to an embodiment;

FIGS. 4A to 4D are flow diagrams of an example of a method of monitoring a storage system according to embodiments;

FIG. 5 is a block diagram of an example of another electronic processing system according to an embodiment; and

FIGS. 6A to 6G are flow diagrams of an example of a method of managing storage according to embodiments.

### DESCRIPTION OF EMBODIMENTS

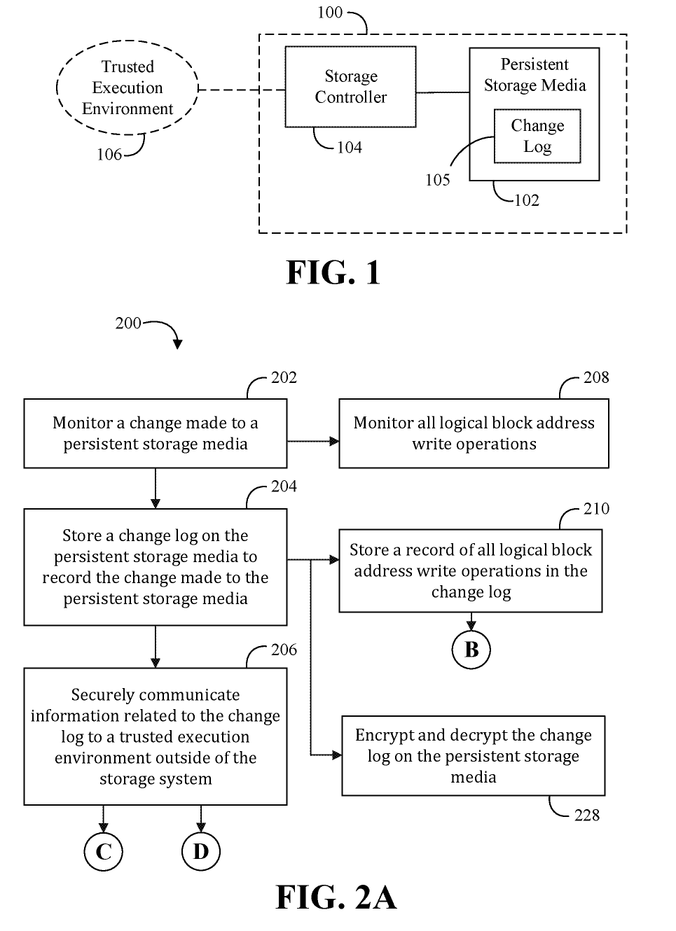

Turning now to FIG. 1, embodiments of a storage system 100 may include a persistent storage media 102, a storage controller 104 coupled to the persistent storage media 102, and code stored on the persistent storage media 102. Advantageously, when the code is executed by the storage controller 104 the code is to monitor a change made to the persistent storage media 102, store a change log 105 on the persistent storage media 102 to record the change made to the persistent storage media 102, and securely communicate information related to the change log 105 to a trusted execution environment 106 outside of the storage system 100.

For example, the code may be further configured to monitor all logical block address (LBA) write operations and the code may also store a record of all LBA write operations in the change log 105. The change log 105 may include a logical to physical (L2P) table and the code may also store dirty bits in the L2P table corresponding to the LBA write operations. For example, dirty bits may refer to one or more bits in a record that indicate that contents of a data location associated with those one or more bits has been changed. In some embodiments of the storage system 100, the code may also store an array of dirty bits corresponding to the LBA write operations in the change log 105. For example, the array of dirty bits may be a compressed array of dirty bits.

Alternatively, the code may also perform an interval and segment analysis to monitor the changes made to the persistent storage media 102 occurring since a most recent security scan to update the change log 105. In another alternative, the code may also perform a binary tree search analysis to monitor the changes made to the persistent storage media 102 occurring since a most recent security scan to update the change log 105.

In any of the above examples, the code may also provide a current size of the change log 105 to the trusted execution environment 106 in response to a corresponding request from the trusted execution environment 106. The code may be further configured to provide a list of changed logical block addresses to the trusted execution environment 106 in response to a corresponding request from the trusted execution environment 106. The code may be further configured to clear a dirty bit in the change log 105 in response to a corresponding request from the trusted execution environment 106. For example, the code may be further configured to encrypt and decrypt the change log 105 on the persistent storage media 102.

In some embodiments of the storage system 100, the code to securely communicate information related to the change log 105 to the trusted execution environment 106 outside of the storage system 100 may include code to encrypt and decrypt the secure communication. For example, the code may include code to communicate over a sideband interface with the trusted execution environment 106. For example, the code may include code to communicate over a secure socket layer (SSL) encryption communication channel or a transport layer security (e.g. Transport Layer Security (TLS) Protocol Version 1.2, August 2008). For example, the code may include code to communicate over an AT attachment (ATA) pass through channel.

In any of the above examples, the persistent storage media 102 may include a hard disk drive. Alternatively, the persistent storage media 102 may include a solid state drive. Alternatively, the persistent storage media 102 may include a non-volatile memory. Alternatively, the persistent storage media 102 may include a hybrid system including both a hard disk drive and a solid state drive. Alternatively, the persistent storage media 102 may include both a solid state drive (SSD) and a non-volatile memory (NVM). For example, firmware for the storage controller 104 may be stored on the NVM that is tightly coupled to the storage controller 104 and separate from the main storage volume of the SSD. For example, the code and the change log 105 may be stored on the NVM that is tightly coupled to the storage controller 104.

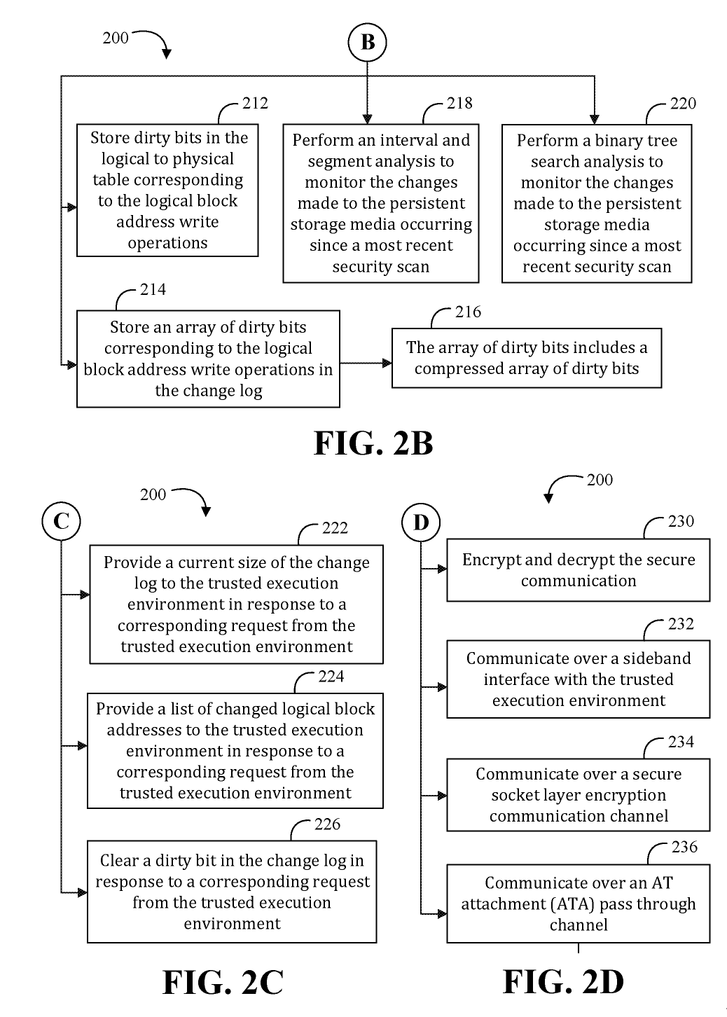

Turning now to FIGS. 2A to 2D, embodiments of a method 200 of controlling a storage system may include monitoring a change made to a persistent storage media at block 202, storing a change log on the persistent storage media to record the change made to the persistent storage media at block 204, and securely communicating information related to the change log to a trusted execution environment outside of the storage system at block 206. For example, the method 200 may further include monitoring all logical block address write operations at block 208, and storing a record of all logical block address write operations in the change log at block 210.

The method 200 may generally be implemented in a storage system such as, for example, the storage system 100 (FIG. 1), already discussed. More particularly, the method 200 may be implemented as a module or related component in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 200 may be written in any combination of one or more programming languages, including an object oriented programming language such as JAVA, SMALLTALK, C++ or the like and conventional procedural programming languages, such as the “C” programming language or similar programming languages.

In some embodiments of the method 200, the change log may include a logical to physical (L2P) table, and the method 200 may further include storing dirty bits in the logical to physical table corresponding to the logical block address write operations at block 212. For example, the method 200 may further include storing an array of dirty bits corresponding to the logical block address write operations in the change log at block 214. The array of dirty bits may include a compressed array of dirty bits (e.g., at block 216).

Some embodiments of the method 200 may further include performing an interval and segment analysis to monitor the changes made to the persistent storage media occurring since a most recent security scan at block 218. Some embodiments of the method 200 may further include performing a binary tree search analysis to monitor the changes made to the persistent storage media occurring since a most recent security scan at block 220. For example, the persistent storage media can be mapped into search nodes, which each search node having two child nodes. A change in the persistent storage media may be detected by traversing the binary search tree to compare, for example, checksums corresponding to the search nodes.

In any of the above examples, the method 200 may further include providing a current size of the change log to the trusted execution environment in response to a corresponding request from the trusted execution environment at block 222. The method 200 may further include providing a list of changed logical block addresses to the trusted execution environment in response to a corresponding request from the trusted execution environment at block 224. The method 200 may further include clearing a dirty bit in the change log in response to a corresponding request from the trusted execution environment at block 226 (e.g. if the trusted execution environment confirms the modification).

The method 200 may further include encrypting and decrypting the change log on the persistent storage media at block 228. In some examples, securely communicating information related to the change log to a trusted execution environment outside of the storage system may include encrypting and decrypting the secure communication at block 230. For example, securely communicating information related to the change log to a trusted execution environment outside of the storage system may include communicating over a sideband interface with the trusted execution environment at block 232. The method 200 may include communicating over a secure socket layer encryption communication channel at block 234. The method 200 may include communicating over an advanced technology/AT attachment (ATA) pass through channel at block 236.

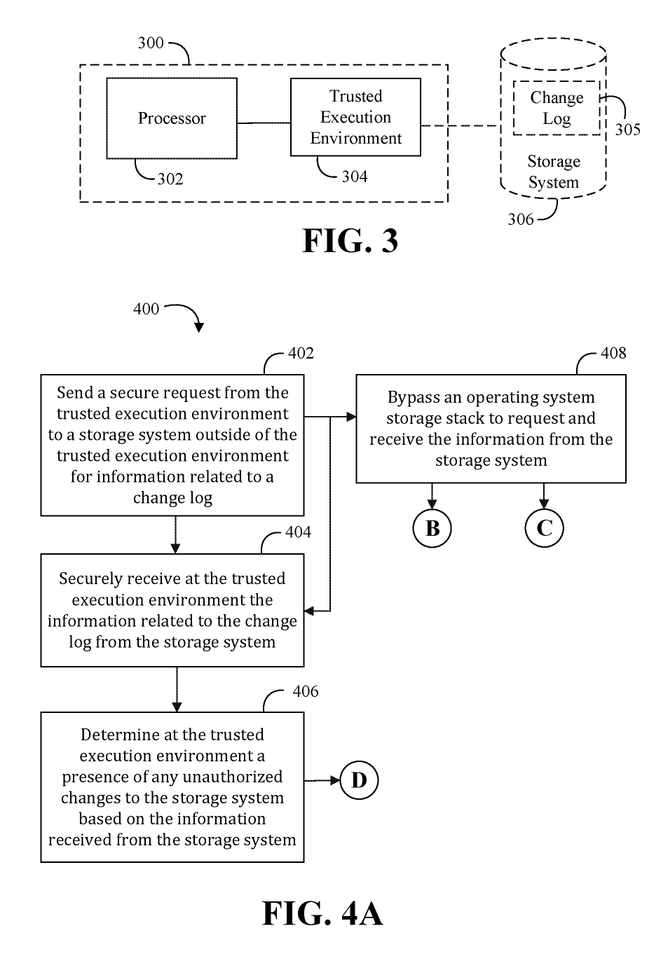

Turning now to FIG. 3, embodiments of an electronic processing system 300 may include a processor 302, and a trusted execution environment 304 coupled to the processor 302. Advantageously, the trusted execution environment 304 may include security code (e.g. software instructions) which when executed by the processor 302 is to securely request information related to a change log 305 from a storage system 306 outside of the trusted execution environment 304, securely receive information related to the change log 305 from the storage system 306 outside the trusted execution environment, and determine the presence of any unauthorized changes to the storage system 306 based on the information received from the storage system 306.

For example, the security code may be further configured to bypass an operating system storage stack to request and receive the information from the storage system 306. The security code to bypass the operating system storage stack may include code to encrypt and decrypt the securely requested and received information. The security code to bypass the operating system storage stack may include code to communicate over a sideband interface with the storage system. For example, the security code to bypass the operating system storage stack may include code to communicate over a secure socket layer encryption communication channel. For example, the security code to bypass the operating system storage stack may include code to communicate over an ATA pass through channel.

In some embodiments of the electronic processing system 300, the security code may be further configured to request a current size of the change log 305 from the storage system 306. The security code may be further configured to request a list of changed logical block addresses from the storage system 306. The security code may be further configured to request the storage system to clear a dirty bit in the change log 305. For example, the received information may correspond to LBA write operations recorded in the change log 305. The received information may correspond to dirty bits in a L2P table corresponding to the LBA write operations recorded in the change log 305. The received information may also correspond to an array of dirty bits corresponding to the LBA write operations recorded in the change log 305. The array of dirty bits may be a compressed array of dirty bits.

Advantageously, in some embodiments of the electronic processing system 300 the security code may be further configured to detect a rootkit attack based on the information received from the storage system 306. For example, a rootkit may refer to a collection of computer software, typically malicious, designed to enable access to a computer or areas of its software that would not otherwise be allowed (for example, to an unauthorized user) while at the same time masking its existence or the existence of other software.

The security code may also perform a malware analysis based on the information received from the storage system 306. For example, malware may refer to malicious software, including any software used to disrupt computer operations, gather sensitive information, gain access to private computer systems, or display unwanted advertising. Malware analysis may refer to the processing of identifying malware on the storage system 306. The security code may also perform a forensic analysis based on the information received from the storage system 306. For example, forensic analysis may refer to identifying, preserving, recovering, and/or otherwise analyzing information related to the storage system 306.

For example, the security code may also map changed LBAs to an operating system file system based on the information received from the storage system 306. The security code may also capture runtime information about file system changes based on the information received from the storage system 306. For example, the security code may also determine if an LBA changed with no corresponding file modification identified in the operating system file system based on the information received from the storage system 306. In any of the above examples, the security code may also remediate any unauthorized changes to the storage system 306.

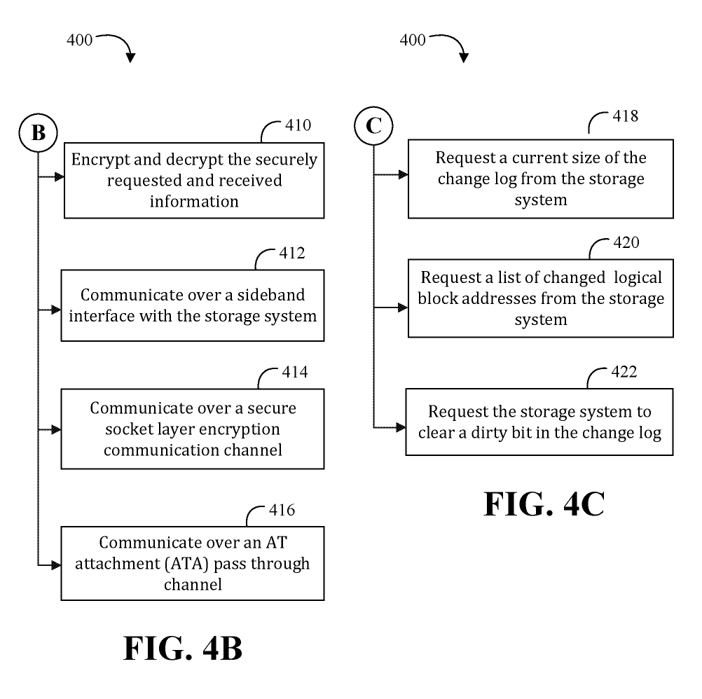

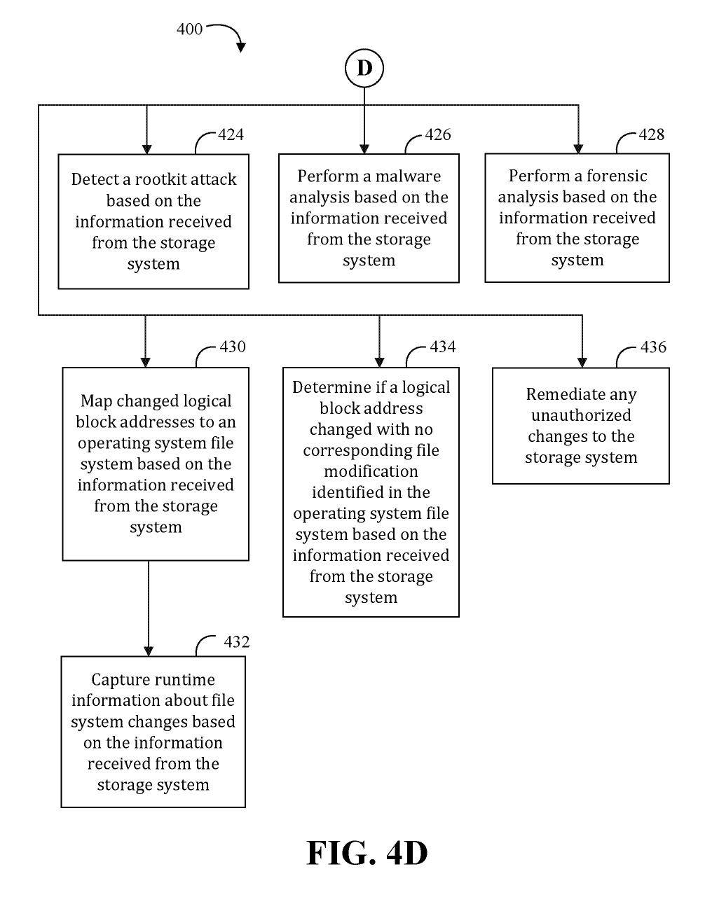

Turning now to FIGS. 4A to 4D, embodiments of a method 400 of monitoring a storage system may include sending a secure request from a trusted execution environment to a storage system outside of the trusted execution environment for information related to a change log at block 402, securely receiving at the trusted execution environment the information related to the change log from the storage system at block 404, and determining at the trusted execution environment a presence of any unauthorized changes to the storage system based on the information received from the storage system at block 406. The method 400 may further include bypassing an operating system storage stack to request and receive the information from the storage system at block 408. For example, an operating system storage stack may refer to a collection of storage media which store various components or portions of the operating system.

The method 400 may generally be implemented in an electronic processing system such as, for example, the electronic processing system 300 (FIG. 3), already discussed. More particularly, the method 400 may be implemented as a module or related component in configurable logic such as, for example, PLAs, FPGAs, CPLDs, in fixed-functionality hardware logic using circuit technology such as, for example, ASIC, CMOS or TTL technology, or any combination thereof. For example, computer program code to carry out operations shown in the method 400 may be written in any combination of one or more programming languages, including an obj ect oriented programming language such as JAVA, SMALLTALK, C++ or the like and conventional procedural programming languages, such as the “C” programming language or similar programming languages.

Some embodiments of the method 400 may further include encrypting and decrypting the securely requested and received information at block 410. The method 400 may further include communicating over a sideband interface with the storage system at block 412. For example, the method 400 may further include communicating over a secure socket layer encryption communication channel at block 414. The method 400 may further include communicating over an ATA pass through channel at block 416.

Some embodiments of the method 400 may further include requesting a current size of the change log from the storage system at block 418. The method 400 may further include requesting a list of changed logical block addresses from the storage system at block 420. The method 400 may further include requesting the storage system to clear a dirty bit in the change log at block 422.

Advantageously, some embodiments of the method 400 may further include detecting a rootkit attack based on the information received from the storage system at block 424. The method 400 may further include performing a malware analysis based on the information received from the storage system at block 426. The method 400 may further include performing a forensic analysis based on the information received from the storage system at block 428. Some embodiments of the method 400 may further include mapping changed logical block addresses to an operating system file system based on the information received from the storage system at block 430. For example, the method 400 may further include capturing runtime information about file system changes based on the information received from the storage system at block 432. The method 400 may further include determining if a logical block address changed with no corresponding file modification identified in the operating system file system based on the information received from the storage system at block 434. In any of the above examples, the method 400 may further include remediating any unauthorized changes to the storage system at block 436.

As noted above, security software may rely on OS functions to detect compromised drive changes, and/or may periodically scan the persistent storage to check for malware. Unfortunately, these techniques may be unreliable (e.g., malware can change system time making time-based change detection ineffective), and/or cause large performance degradation. Advantageously, some embodiments may provide an SSD change log for disk forensics. Advantageously, some embodiments may utilize a sideband interface to query and/or export all disk changes directly to and from security software. Advantageously, some embodiments may provide a solid-state drive/persistent storage change log feature to assist real time disk forensics, rapid compromised storage status check, ransomware detection/mitigation and other new usages.

In accordance with some embodiments, the drive system may track all LBA changes and directly export a change log to security software for forensics and malware analysis investigation. For example, the change log can also be encrypted to allow for additional confidentiality. Advantageously, new commands may be added to the SSD firmware for communicating directly with the security software. Without being limited to theory of operation, embodiments may provide the benefit of an accurate change log from the SSD directly without any manipulation from malicious OS components (e.g., no dependence on an OS storage stack), and focus on reporting changes only (e.g., does not need to inspect whole drive, resulting in better performance). Advantageously, some embodiments may provide a full-drive malware scan taking significantly less time than a full-drive read, because the change log focuses on changes only.

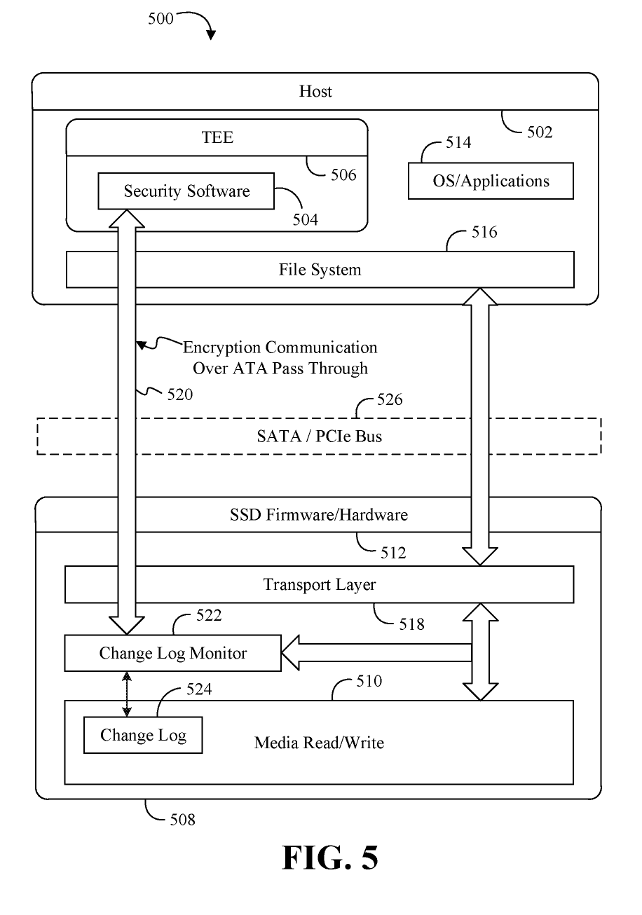

Turning now to FIG. 5, embodiments of an electronic processing system 500 may include a host portion 502 (e.g., including a processor and dynamic random access memory/DRAM coupled to the processor) and security code 504 stored on the memory which when executed by the processor is to provide a trusted execution environment (TEE) 506 (e.g., together with other firmware/hardware supporting the TEE). The system 500 may further include a storage system 508 coupled to the processor from outside of the trusted execution environment 506. For example, the storage system 508 may include persistent storage media 510, a storage controller 512 coupled to the persistent storage media 510, operating system (OS) code 514 stored on the persistent storage media 510 which when executed by the processor (e.g., of the host 502) is to manage a file system 516 for the electronic processing system 500, and storage controller code stored on the persistent storage media 510 which when executed by the storage controller 512 is to provide a transport layer 518 between the file system 516 and the persistent storage media 510. Advantageously, the processing system 500 may further include a sideband interface 520 coupled between the storage system 508 and the trusted execution environment 506 bypassing the transport layer 518 and/or the file system 516.

In some embodiments of the electronic processing system 500, the storage controller code may also monitor a change made to the persistent storage media 510 (e.g., with a change log monitor 522), store a change log 524 on the persistent storage media 510 to record the change made to the persistent storage media 510, and securely communicate information related to the change log 524 to the trusted execution environment 506. For example, the security code 504 may also securely request and receive information related to the change log 524 from the storage system 508, and determine a presence of any unauthorized changes to the storage system 508 based on the information received from the storage system 508.

For example, the storage controller code may also monitor all LBA write operations and to store a record of all LBA write operations in the change log 524. For example, the change log 524 may include an L2P table and the storage controller code may store dirty bits in the L2P table corresponding to the LBA write operations.

In some embodiments of the electronic processing system 500, the security code 504 may issue a command to the storage controller code to request a current size of the change log 524 from the storage controller code and the storage controller code may provide the current size of the change log 524 to the security code in response to the request. The security code 504 may also issue a command to request a list of changed LBAs from the storage controller code and the storage controller code may provide the list of changed LBAs to the security code 504 in response to the request. The security code 504 may also issue a command to request the storage controller code to clear a dirty bit in the change log 524 and the storage controller code may clear the dirty bit in the change log 524 in response to the request from the security code 504. For example, the security code 504 and storage controller code may be configured to encrypt and decrypt the change log 524 on the persistent storage media 510 and/or also to encrypt and decrypt the securely requested and received information.

In some embodiments of the electronic processing system 500, the sideband interface 520 may include a hardwired connection outside of any shared bus 526 of the electronic processing system 500. The shared bus 526 may be compliant with, for example, SATA (Serial Advanced Technology Attachment, e.g., SATA Rev. 3.0 Specification, May 27, 2009, SATA International Organization/SATA-IO), PCI-e (Peripheral Components Interconnect Express, e.g., PCI Express x16 Graphics 150W-ATX Specification 1.0, PCI Special Interest Group), and so forth. Alternatively (e.g., or additionally), the sideband interface 520 may include a secure communication channel provided on the shared bus 526 of the electronic processing system 500. For example, the secure communication channel may include a secure socket layer (SSL) encryption communication channel. For example, the secure communication channel may include an AT attachment (ATA) pass through channel.

In some embodiments of the electronic processing system 500, the persistent storage media 510 may include a hard disk drive (HDD). The persistent storage media 510 may include a solid state drive (SSD). The persistent storage media 510 may include a non-volatile memory (NVM). The persistent storage media 510 may include a hybrid system including both an HDD and an SSD. The persistent storage media 510 may include both an SSD and an NVM. For example, storage controller code for the storage controller 512 may be stored on the NVM which is tightly coupled to the storage controller 512 and separate from the main storage volume of the SSD. For example, the change log 524 may be stored on the NVM which is tightly coupled to the storage controller 512. For example, the OS code 514 may be stored on the main storage volume of the SSD.

Advantageously, in some embodiments of the electronic processing system 500, the security code 504 may also detect a rootkit attack based on the information received from the storage system 508. The security code 504 may also perform a malware analysis based on the information received from the storage system 508. The security code 504 may also perform a forensic analysis based on the information received from the storage system 508. The security code 504 may also map changed LBAs to an OS file system 516 based on the information received from the storage system 508. The security code 504 may also capture runtime information about file system 516 changes based on the information received from the storage system 508. The security code 504 may also determine if an LBA changed with no corresponding file modification identified in the OS file system 516 based on the information received from the storage system 508. In any of the above examples, the security code 504 may also remediate any unauthorized changes to the storage system 508.

In some embodiments of the electronic processing system 500, the storage system 508 may advantageously include a change log monitor mechanism (e.g., change log monitor 522) provided in SSD firmware to monitor and record every LBA write operation. A secure export mechanism may be provided to export change log information to host software over a secure channel. For example, a change log monitor module 522 may capture every LBA write, and logs the change. For example, this can be done via dirty/changed bit(s) in an L2P table, or via a dirty bit-array (optionally compressed) per tracking-granularity. Alternately, interval/segment-trees or binary-search-tree based algorithms can be used to track the set of LBA ranges that have changed since the last security software scan of the area.

Some embodiments of the system 500 may advantageously support an encrypted communication channel over an SSD software stack. For example, to export change log data to security software running in the trusted execution environment (TEE), a secure socket layer (SSL) or similar encryption communication channel may be utilized to prevent data manipulation (for change-query commands) by untrusted OS code running in an (assumed) potentially compromised system. Examples of TEE include execution environments isolated from malware actions in the OS, such as via VT-x, SGX, Bios, chipset/FPGA or similar isolated execution environments. Some embodiments of the system 500 may advantageously support an encrypted communication protocol. For example, bi-directional authentication protocols may be utilized to initially establish trust between the storage system 508 and the TEE 506. For example, the storage system 508 and/or the TEE may maintain certificates and may utilize a certificate matching process to initially establish trust. If the certificates are properly authenticated, a secure session may be created with unique session keys to seed subsequent encrypted communication. For example, once trust is established a set of commands may be provided to set up keys for encrypted communication. The TEE 506 can then issue commands from various OS components between security software in the TEE 506 and the storage system 508.

Some embodiments of the system 500 may advantageously provide new change log query commands and/or protocols as SSD commands that can be issued by the security software to the storage system over the secure communication channel. For example, a change log size query command may be nominally referred to as CHANGE_LOG_SIZE_QUERY_CMD(LBA range). For example, this command could request current change log data size from the SSD for the specified LBA range, which could be for the entire SSD. Another example is a query change log command which may nominally be referred to as CHANGE_LOG_QUERY_CMD(LBA range). For example, this command could request current change log data from the SSD for the specified LBA range, which could be for the entire SSD. For example, the data returned from the SSD could be a set of zero or more LBA-subranges that have changed within the specified LBA-range. The returned change log data could also contain integrity check values (ICVs) and/or hashes to describe the changes to the specified LBA range. Another example, is a clear change range command which may nominally be referred to as CHANGE_LOG_CLEAR_CMD(LBA range). For example, this command could clear the change log in the specified LBA range. For example, all LBAs marked as dirty within the specified range may be reset to be considered clean. For example, disk forensics software may use this command to mark a range as clean after it has finished scanning it, so that subsequent scans don't repeat checks of this range unnecessarily.

Some embodiments of the system 500 may advantageously support security software that can analyze change log data from the SSD to know how many and/or which LBAs have changed. For example, disk forensics software can map original LBA sectors to OS files with file system information generated at the time the OS was first set up (or is otherwise considered to be clean). The disk forensics software can then map changed LBA sectors to OS files to get a complete modified file name mapping.

Security software can also capture runtime information about file system changes (considered untrustworthy). For example, if some LBAs are written as deciphered from the trusted SSD change logs, but the OS did not report any corresponding (e.g., with hashes) file related information, it is likely that either malicious software wrote a sector directly or hidden files were created by malicious code. Security software can then remediate the files, per its mechanisms and policies. For example, checkpointing can be leveraged to restore the affected drive portions to a prior clean checkpoint state.

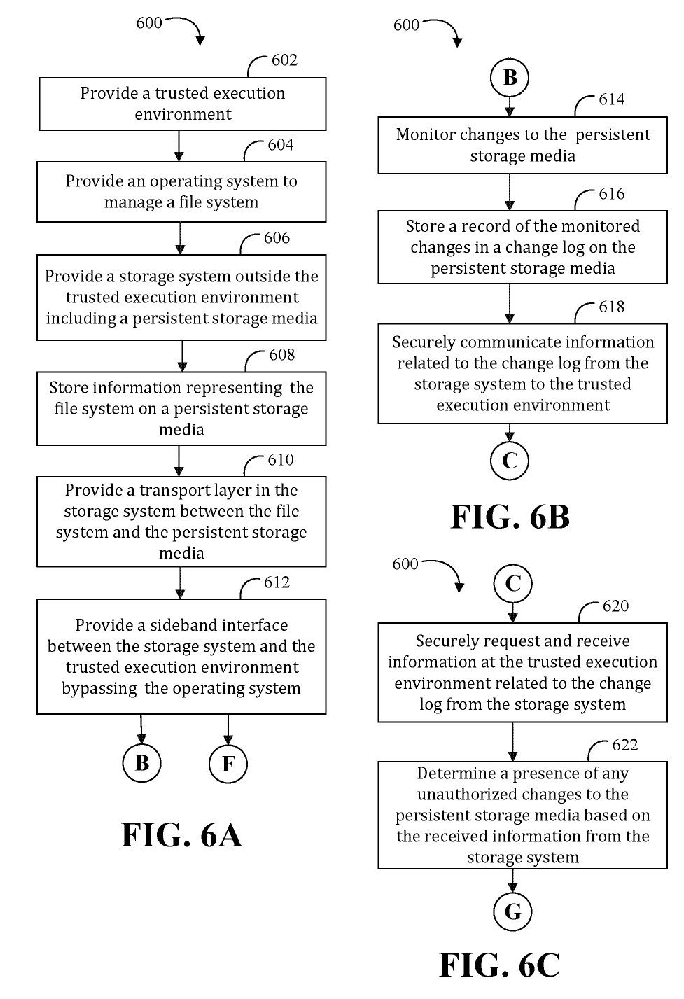

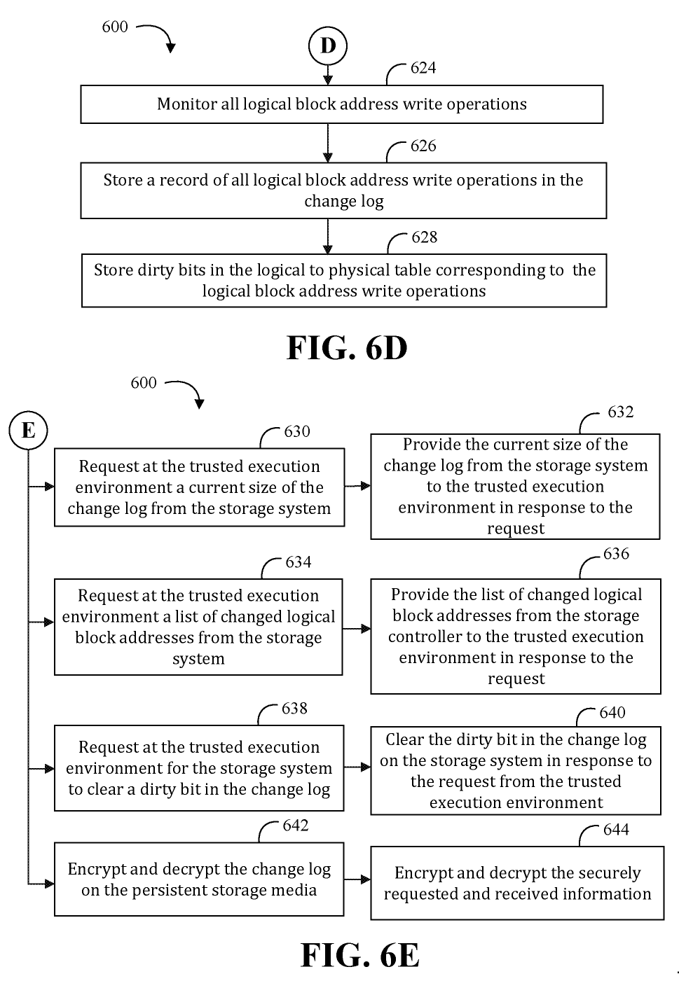

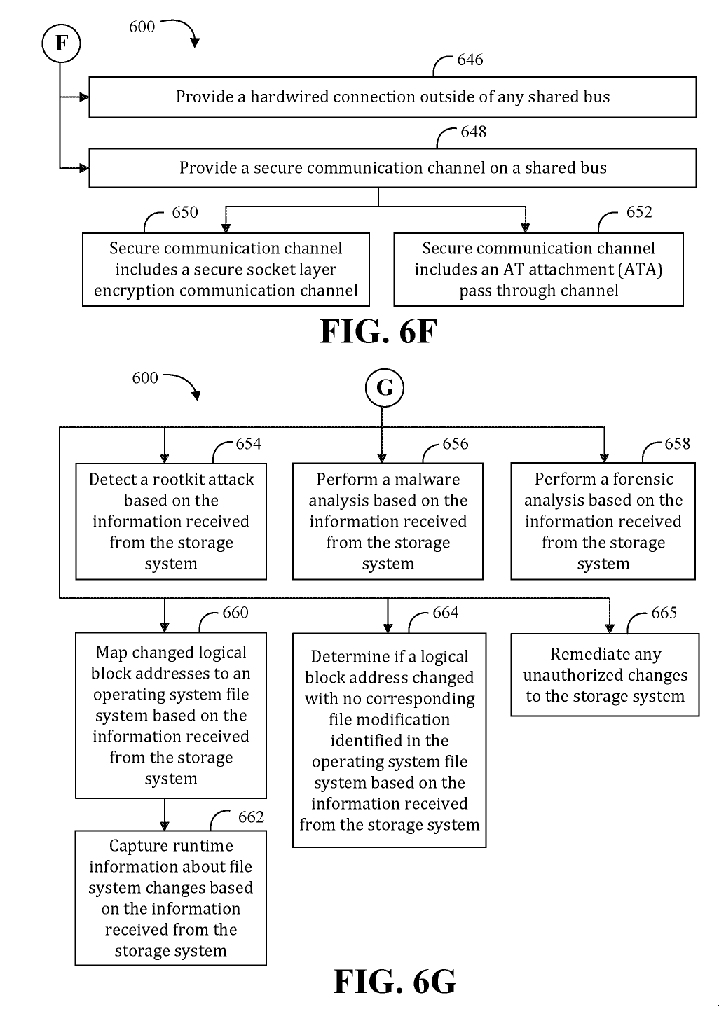

Turning now to FIGS. 6A to 6G, a method 600 of managing storage may include providing a trusted execution environment at block 602, providing an operating system to manage a file system at block 604, providing a storage system outside the trusted execution environment including a persistent storage media at block 606, storing information representing the file system on a persistent storage media at block 608, providing a transport layer in the storage system between the file system and the persistent storage media at block 610, and providing a sideband interface between the storage system and the trusted execution environment bypassing the operating system at block 612.

The method 600 may generally be implemented in an electronic processing system such as, for example, the electronic processing system 500 (FIG. 5), already discussed. More particularly, the method 600 may be implemented as a module or related component in configurable logic such as, for example, PLAs, FPGAs, CPLDs, in fixed-functionality hardware logic using circuit technology such as, for example, ASIC, CMOS or TTL technology, or any combination thereof. For example, computer program code to carry out operations shown in the method 600 may be written in any combination of one or more programming languages, including an object oriented programming language such as JAVA, SMALLTALK, C++ or the like and conventional procedural programming languages, such as the “C” programming language or similar programming languages.

For example, the method 600 may further include monitoring changes to the persistent storage media at block 614, storing a record of the monitored changes in a change log on the persistent storage media at block 616, and securely communicating information related to the change log from the storage system to the trusted execution environment at block 618. For example, the method 600 may further include securely requesting and receiving information at the trusted execution environment related to the change log from the storage system at block 620, and determining a presence of any unauthorized changes to the persistent storage media based on the received information from the storage system at block 622. For example, the method 600 may further include monitoring all logical block address write operations at block 624, and storing a record of all logical block address write operations in the change log at block 626. The change log may include a logical to physical table and the method 600 may further include storing dirty bits in the logical to physical table corresponding to the logical block address write operations at block 628.

Some embodiments of the method 600 may further include requesting at the trusted execution environment a current size of the change log from the storage system at block 630, and providing the current size of the change log from the storage system to the trusted execution environment in response to the request at block 632. The method 600 may further include requesting at the trusted execution environment a list of changed logical block addresses from the storage system at block 634, and providing the list of changed logical block addresses from the storage controller to the trusted execution environment in response to the request at block 636. For example, the method 600 may further include requesting at the trusted execution environment for the storage system to clear a dirty bit in the change log at block 638, and clearing the dirty bit in the change log on the storage system in response to the request from the trusted execution environment at block 640. The method 600 may further include encrypting and decrypting the change log on the persistent storage media at block 642, and encrypting and decrypting the securely requested and received information at block 644.

In some embodiments of the method 600, providing the sideband interface may include providing a hardwired connection outside of any shared bus at block 646. In some embodiments of the method 600, providing the sideband interface may include providing a secure communication channel on a shared bus at block 648. For example, the secure communication channel may include a secure socket layer encryption communication channel at block 650. For example, the secure communication channel may include an AT attachment (ATA) pass through channel at block 652.

Advantageously, some embodiments of the method 600 may further include detecting a rootkit attack based on the information received from the storage system at block 654. The method 600 may further include performing a malware analysis based on the information received from the storage system at block 656. The method 600 may further include performing a forensic analysis based on the information received from the storage system at block 658. Some embodiments of the method 600 may further include mapping changed logical block addresses to an operating system file system based on the information received from the storage system at block 660. For example, the method 600 may further include capturing runtime information about file system changes based on the information received from the storage system at block 662. The method 600 may further include determining if a logical block address changed with no corresponding file modification identified in the operating system file system based on the information received from the storage system at block 664. In any of the above examples, the method 600 may further include remediating any unauthorized changes to the storage system at block 665.

### ADDITIONAL NOTES AND EXAMPLES

Example 1 may include a storage system, comprising persistent storage media, a storage controller coupled to the persistent storage media, and code stored on the persistent storage media which when executed by the storage controller is to monitor a change made to the persistent storage media, store a change log on the persistent storage media to record the change made to the persistent storage media, and securely communicate information related to the change log to a trusted execution environment outside of the storage system.

Example 2 may include the storage system of Example 1, wherein the code is further to monitor all logical block address write operations and wherein the code is further to store a record of all logical block address write operations in the change log.

Example 3 may include the storage system of Example 2, wherein the change log comprises a logical to physical table and wherein the code is further to store dirty bits in the logical to physical table corresponding to the logical block address write operations.

Example 4 may include the storage system of Example 2, wherein the code is further to store an array of dirty bits corresponding to the logical block address write operations in the change log.

Example 5 may include the storage system of Example 4, wherein the array of dirty bits comprises a compressed array of dirty bits.

Example 6 may include the storage system of Example 2, where the code is further to perform an interval and segment analysis to monitor the changes made to the persistent storage media occurring since a most recent security scan.

Example 7 may include the storage system of Example 2, where the code is further to perform a binary tree search analysis to monitor the changes made to the persistent storage media occurring since a most recent security scan.

Example 8 may include the storage system of Example 1 to Example 7, wherein the code is further to provide a current size of the change log to the trusted execution environment in response to a corresponding request from the trusted execution environment.

Example 9 may include the storage system of Example 1 to Example 7, wherein the code is further to provide a list of changed logical block addresses to the trusted execution environment in response to a corresponding request from the trusted execution environment.

Example 10 may include the storage system of Example 1 to Example 7, wherein the code is further to clear a dirty bit in the change log in response to a corresponding request from the trusted execution environment.

Example 11 may include the storage system of any of Example 1 to Example 7, wherein the code is further to encrypt and decrypt the change log on the persistent storage media.

Example 12 may include the storage system of Example 1, wherein the code to securely communicate information related to the change log to the trusted execution environment outside of the storage system includes code to encrypt and decrypt the secure communication.

Example 13 may include the storage system of Example 1, wherein the code to securely communicate information related to the change log to the trusted execution environment outside of the storage system includes code to communicate over a sideband interface with the trusted execution environment.

Example 14 may include the storage system of Example 1, wherein the code to securely communicate information related to the change log to the trusted execution environment outside of the storage system includes code to communicate over a secure socket layer encryption communication channel.

Example 15 may include the storage system of Example 1, wherein the code to securely communicate information related to the change log to the trusted execution environment outside of the storage system includes code to communicate over an AT attachment (ATA) pass through channel.

Example 16 may include the storage system of any of Example 1 to Example 15, wherein the persistent storage media comprises a hard disk drive.

Example 17 may include the storage system of any of Example 1 to Example 15, wherein the persistent storage media comprises a solid state drive.

Example 18 may include the storage system of any of Example 1 to Example 15, wherein the persistent storage media comprises a non-volatile memory.

Example 19 may include the storage system of any of Example 1 to Example 15, wherein the persistent storage media comprises a hybrid system including both a hard disk drive and a solid state drive.

Example 20 may include the storage system of any of Example 1 to Example 15, wherein the persistent storage media comprises both a solid state drive and a non-volatile memory.

Example 21 may include a method of controlling a storage system, comprising monitoring a change made to a persistent storage media, storing a change log on the persistent storage media to record the change made to the persistent storage media, and securely communicating information related to the change log to a trusted execution environment outside of the storage system.

Example 22 may include the method of Example 21, further comprising monitoring all logical block address write operations, and storing a record of all logical block address write operations in the change log.

Example 23 may include the method of Example 22, wherein the change log comprises a logical to physical table, further comprising storing dirty bits in the logical to physical table corresponding to the logical block address write operations.

Example 24 may include the method of Example 22, further comprising storing an array of dirty bits corresponding to the logical block address write operations in the change log.

Example 25 may include the method of Example 24, wherein the array of dirty bits comprises a compressed array of dirty bits.

Example 26 may include the method of Example 22, further comprising performing an interval and segment analysis to monitor the changes made to the persistent storage media occurring since a most recent security scan.

Example 27 may include the method of Example 22, further comprising performing a binary tree search analysis to monitor the changes made to the persistent storage media occurring since a most recent security scan.

Example 28 may include the method of Example 21 to Example 27, further comprising providing a current size of the change log to the trusted execution environment in response to a corresponding request from the trusted execution environment.

Example 29 may include the method of Example 21 to Example 27, further comprising providing a list of changed logical block addresses to the trusted execution environment in response to a corresponding request from the trusted execution environment.

Example 30 may include the method of Example 21 to Example 27, further comprising clearing a dirty bit in the change log in response to a corresponding request from the trusted execution environment.

Example 31 may include the method of any of Example 21 to Example 27, further comprising encrypting and decrypting the change log on the persistent storage media.

Example 32 may include the method of Example 21, wherein securely communicating information related to the change log to a trusted execution environment outside of the storage system comprises encrypting and decrypting the secure communication.

Example 33 may include the method of Example 21, wherein securely communicating information related to the change log to a trusted execution environment outside of the storage system comprises communicating over a sideband interface with the trusted execution environment.

Example 34 may include the method of Example 21, wherein securely communicating information related to the change log to a trusted execution environment outside of the storage system comprises communicating over a secure socket layer encryption communication channel.

Example 35 may include the method of Example 21, wherein securely communicating information related to the change log to a trusted execution environment outside of the storage system comprises communicating over an AT attachment (ATA) pass through channel.

Example 36 may include an electronic processing system, comprising a processor, and a trusted execution environment coupled to the processor, wherein the trusted execution environment includes security code which when executed by the processor is to securely request information related to a change log from a storage system outside of the trusted execution environment, securely receive information related to the change log from the storage system outside the trusted execution environment, and determine the presence of any unauthorized changes to the storage system based on the information received from the storage system.

Example 37 may include the electronic processing system of Example 36, wherein the security code is further to bypass an operating system storage stack to request and receive the information from the storage system.

Example 38 may include the electronic processing system of Example 37, wherein the security code to bypass the operating system storage stack includes code to encrypt and decrypt the securely requested and received information.

Example 39 may include the electronic processing system of Example 38, wherein the security code to bypass the operating system storage stack includes code to communicate over a sideband interface with the storage system.

Example 40 may include the electronic processing system of Example 37, wherein the security code to bypass the operating system storage stack includes code to communicate over a secure socket layer encryption communication channel.

Example 41 may include the electronic processing system of Example 37, wherein the security code to bypass the operating system storage stack includes code to communicate over an AT attachment (ATA) pass through channel.

Example 42 may include the electronic processing system of Example 36 to Example 41, wherein the security code is further to request a current size of the change log from the storage system.

Example 43 may include the electronic processing system of Example 36 to Example 41, wherein the security code is further to request a list of changed logical block addresses from the storage system.

Example 44 may include the electronic processing system of Example 36 to Example 41, wherein the security code is further to request the storage system to clear a dirty bit in the change log.

Example 45 may include the electronic processing system of Example 36, wherein the received information corresponds to logical block address write operations recorded in the change log.

Example 46 may include the electronic processing system of Example 45, wherein the received information corresponds to dirty bits in a logical to physical table corresponding to the logical block address write operations recorded in the change log.

Example 47 may include the electronic processing system of Example 45, wherein the received information corresponds to an array of dirty bits corresponding to the logical block address write operations recorded in the change log.

Example 48 may include the electronic processing system of Example 47, wherein the array of dirty bits comprises a compressed array of dirty bits.

Example 49 may include the electronic processing system of Example 36, wherein the security code is further to detect a rootkit attack based on the information received from the storage system.

Example 50 may include the electronic processing system of Example 36, wherein the security code is further to perform a malware analysis based on the information received from the storage system.

Example 51 may include the electronic processing system of Example 36, wherein the security code is further to perform a forensic analysis based on the information received from the storage system.

Example 52 may include the electronic processing system of Example 36, wherein the security code is further to map changed logical block addresses to an operating system file system based on the information received from the storage system.

Example 53 may include the electronic processing system of Example 52, wherein the security code is further to capture runtime information about file system changes based on the information received from the storage system.

Example 54 may include the electronic processing system of Example 36, wherein the security code is further to determine if a logical block address changed with no corresponding file modification identified in the operating system file system based on the information received from the storage system.

Example 55 may include the electronic processing system of any of Example 49 to Example 54, wherein the security code is further to remediate any unauthorized changes to the storage system.

Example 56 may include a method of monitoring a storage system, comprising sending a secure request from a trusted execution environment to a storage system outside of the trusted execution environment for information related to a change log, securely receiving at the trusted execution environment the information related to the change log from the storage system outside the trusted execution environment, and determining at the trusted execution environment a presence of any unauthorized changes to the storage system based on the information received from the storage system.

Example 57 may include the method of Example 56, further comprising bypassing an operating system storage stack to request and receive the information from the storage system.

Example 58 may include the method of Example 57, further comprising encrypting and decrypting the securely requested and received information.

Example 59 may include the method of Example 58, further comprising communicating over a sideband interface with the storage system.

Example 60 may include the method of Example 57, further comprising communicating over a secure socket layer encryption communication channel.

Example 61 may include the method of Example 57, further comprising communicating over an AT attachment (ATA) pass through channel.

Example 62 may include the method of Example 56 to Example 61, further comprising requesting a current size of the change log from the storage system.

Example 63 may include the method of Example 56 to Example 61, further comprising requesting a list of changed logical block addresses from the storage system.

Example 64 may include the method of Example 56 to Example 61, further comprising requesting the storage system to clear a dirty bit in the change log.

Example 65 may include the method of Example 56, further comprising detecting a rootkit attack based on the information received from the storage system.

Example 66 may include the method of Example 56, further comprising performing a malware analysis based on the information received from the storage system.

Example 67 may include the method of Example 56, further comprising performing a forensic analysis based on the information received from the storage system.

Example 68 may include the method of Example 56, further comprising mapping changed logical block addresses to an operating system file system based on the information received from the storage system.

Example 69 may include the method of Example 68, further comprising capturing runtime information about file system changes based on the information received from the storage system.

Example 70 may include the method of Example 66, further comprising determining if a logical block address changed with no corresponding file modification identified in the operating system file system based on the information received from the storage system.

Example 71 may include the method of any of Example 65 to Example 70, further comprising remediating any unauthorized changes to the storage system.

Example 72 may include an electronic processing system, comprising a processor, memory coupled to the processor, security code stored on the memory which when executed by the processor is to provide a trusted execution environment, a storage system coupled to the processor from outside of the trusted execution environment, the storage system including persistent storage media, a storage controller coupled to the persistent storage media, operating system code stored on the persistent storage media which when executed by the processor is to manage a file system for the electronic processing system, and storage controller code stored on the persistent storage media which when executed by the storage controller is to provide a transport layer between the file system and the persistent storage media, and a sideband interface coupled between the storage system and the trusted execution environment bypassing the file system.

Example 73 may include the electronic processing system of Example 72, wherein the storage controller code is further to monitor a change made to the persistent storage media, store a change log on the persistent storage media to record the change made to the persistent storage media, and securely communicate information related to the change log to the trusted execution environment.

Example 74 may include the electronic processing system of Example 73, wherein the security code is further to securely request and receive information related to the change log from the storage system, and determine a presence of any unauthorized changes to the storage system based on the information received from the storage system.

Example 75 may include the electronic processing system of Example 74, wherein the storage controller code is further to monitor all logical block address write operations and wherein the storage controller code is further to store a record of all logical block address write operations in the change log.

Example 76 may include the electronic processing system of Example 74, wherein the change log comprises a logical to physical table and wherein the storage controller code is further to store dirty bits in the logical to physical table corresponding to the logical block address write operations.

Example 77 may include the electronic processing system of Example 73 to Example 76, wherein the security code is further to request a current size of the change log from the storage controller code and wherein the storage controller code is further to provide the current size of the change log to the security code in response to the request.

Example 78 may include the electronic processing system of Example 73 to Example 76, wherein the security code is further to request a list of changed logical block addresses from the storage controller code and wherein the storage controller code is further to provide the list of changed logical block addresses to the security code in response to the request.

Example 79 may include the electronic processing system of Example 73 to Example 76, wherein the security code is further to request the storage controller code to clear a dirty bit in the change log and wherein the storage controller code is further to clear a dirty bit in the change log in response to the request from the security code.

Example 80 may include the electronic processing system of any of Example 74 to Example 76, wherein the storage controller code is further to encrypt and decrypt the change log on the persistent storage media.

Example 81 may include the electronic processing system of Example 80, wherein the security code is further to encrypt and decrypt the securely requested and received information.

Example 82 may include the electronic processing system of Example 72, wherein the sideband interface includes a hardwired connection outside of any shared bus of the electronic processing system.

Example 83 may include the electronic processing system of Example 72, wherein the sideband interface includes a secure communication channel provided on a shared bus of the electronic processing system.

Example 84 may include the electronic processing system of Example 83, wherein the secure communication channel includes a secure socket layer encryption communication channel.

Example 85 may include the electronic processing system of Example 83, wherein the secure communication channel includes an AT attachment (ATA) pass through channel.

Example 86 may include the electronic processing system of any of Example 72 to Example 85, wherein the persistent storage media comprises a hard disk drive.

Example 87 may include the electronic processing system of any of Example 72 to Example 85, wherein the persistent storage media comprises a solid state drive.

Example 88 may include the electronic processing system of any of Example 72 to Example 85, wherein the persistent storage media comprises a non-volatile memory.

Example 89 may include the electronic processing system of any of Example 72 to Example 85, wherein the persistent storage media comprises a hybrid system including both a hard disk drive and a solid state drive.

Example 90 may include the electronic processing system of any of Example 72 to Example 85, wherein the persistent storage media comprises both a solid state drive and a non-volatile memory.

Example 91 may include the electronic processing system of Example 74, wherein the security code is further to detect a rootkit attack based on the information received from the storage system.

Example 92 may include the electronic processing system of Example 74, wherein the security code is further to perform a malware analysis based on the information received from the storage system.

Example 93 may include the electronic processing system of Example 74, wherein the security code is further to perform a forensic analysis based on the information received from the storage system.

Example 94 may include the electronic processing system of Example 74, wherein the security code is further to map changed logical block addresses to an operating system file system based on the information received from the storage system.

Example 95 may include the electronic processing system of Example 94, wherein the security code is further to capture runtime information about file system changes based on the information received from the storage system.

Example 96 may include the electronic processing system of Example 74, wherein the security code is further to determine if a logical block address changed with no corresponding file modification identified in the operating system file system based on the information received from the storage system.

Example 97 may include the electronic processing system of any of Example 91 to Example 96, wherein the security code is further to remediate any unauthorized changes to the storage system.

Example 98 may include a method of managing storage, comprising providing a trusted execution environment, providing an operating system to manage a file system, providing a storage system outside the trusted execution environment including a persistent storage media, storing information representing the file system on a persistent storage media, providing a transport layer in the storage system between the file system and the persistent storage media, and providing a sideband interface between the storage system and the trusted execution environment bypassing the operating system.

Example 99 may include the method of Example 98, further comprising monitoring changes to the persistent storage media, storing a record of the monitored changes in a change log on the persistent storage media, and securely communicating information related to the change log from the storage system to the trusted execution environment.

Example 100 may include the method of Example 99, further comprising securely requesting and receiving information at the trusted execution environment related to the change log from the storage system, and determining a presence of any unauthorized changes to the persistent storage media based on the received information from the storage system.

Example 101 may include the method of Example 100, further comprising monitoring all logical block address write operations, and storing a record of all logical block address write operations in the change log.

Example 102 may include the method of Example 100, wherein the change log comprises a logical to physical table, further comprising storing dirty bits in the logical to physical table corresponding to the logical block address write operations.

Example 103 may include the method of Example 99 to Example 102, further comprising requesting at the trusted execution environment a current size of the change log from the storage system, and providing the current size of the change log from the storage system to the trusted execution environment in response to the request.

Example 104 may include the method of Example 99 to Example 102, further comprising requesting at the trusted execution environment a list of changed logical block addresses from the storage system, and providing the list of changed logical block addresses from the storage system to the trusted execution environment in response to the request.

Example 105 may include the method of Example 99 to Example 102, further comprising requesting at the trusted execution environment for the storage system to clear a dirty bit in the change log, and clearing the dirty bit in the change log on the storage system in response to the request from the trusted execution environment.

Example 106 may include the method of any of Example 99 to Example 102, further comprising encrypting and decrypting the change log on the persistent storage media.

Example 107 may include the method of Example 106, further comprising encrypting and decrypting the securely requested and received information.

Example 108 may include the method of Example 98, wherein providing the sideband interface comprises providing a hardwired connection outside of any shared bus.

Example 109 may include the method of Example 98, wherein providing the sideband interface comprises providing a secure communication channel on a shared bus.

Example 110 may include the method of Example 109, wherein the secure communication channel includes a secure socket layer encryption communication channel.

Example 111 may include the method of Example 109, wherein the secure communication channel includes an AT attachment (ATA) pass through channel.

Example 112 may include the method of Example 100, further comprising detecting a rootkit attack based on the information received from the storage system.

Example 113 may include the method of Example 100, further comprising performing a malware analysis based on the information received from the storage system.

Example 114 may include the method of Example 100, further comprising performing a forensic analysis based on the information received from the storage system.

Example 115 may include the method of Example 100, further comprising mapping changed logical block addresses to an operating system file system based on the information received from the storage system.

Example 116 may include the method of Example 115, further comprising capturing runtime information about file system changes based on the information received from the storage system.

Example 117 may include the method of Example 100, further comprising determining if a logical block address changed with no corresponding file modification identified in the operating system file system based on the information received from the storage system.

Example 118 may include the method of any of Example 112 to Example 117, further comprising remediating any unauthorized changes to the storage system.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An electronic processing system, comprising:
a processor;
memory coupled to the processor;
security code stored on the memory which when executed by the processor is to provide a trusted execution environment;
a storage system coupled to the processor from outside of the trusted execution environment, the storage system including:
a persistent storage media,
a storage controller coupled to the persistent storage media,
operating system code stored on the persistent storage media which when executed by the processor is to manage a file system for the electronic processing system, and
storage controller code stored on the persistent storage media which when executed by the storage controller is to provide a transport layer between the file system and the persistent storage media; and
a sideband interface coupled between the storage system and the trusted execution environment bypassing the transport layer and the file system.

2. The electronic processing system of claim 1, wherein the storage controller code is further to:
monitor a change made to the persistent storage media;
store a change log on the persistent storage media to record the change made to the persistent storage media; and
securely communicate information related to the change log to the trusted execution environment.

3. The electronic processing system of claim 2, wherein the security code is further to:
securely request and receive information related to the change log from the storage system; and
determine a presence of any unauthorized changes to the storage system based on the information received from the storage system.

4. The electronic processing system of claim 3, wherein the sideband interface includes a secure communication channel provided on a shared bus of the electronic processing system.

5. A storage system, comprising:
a persistent storage media;
a storage controller coupled to the persistent storage media; and
code stored on the persistent storage media which when executed by the storage controller is to:
monitor a change made to the persistent storage media;
store a change log on the persistent storage media to record the change made to the persistent storage media; and
securely communicate information related to the change log to a trusted execution environment outside of the storage system.

6. The storage system of claim 5, wherein the code is further to monitor all logical block address write operations and wherein the code is further to store a record of all logical block address write operations in the change log.

7. The storage system of claim 6, wherein the change log comprises a logical to physical table and wherein the code is further to store dirty bits in the logical to physical table corresponding to the logical block address write operations.

8. The storage system of claim 5, wherein the code to securely communicate information related to the change log to the trusted execution environment outside of the storage system includes code to communicate over a sideband interface with the trusted execution environment.

9. The storage system of claim 5, wherein the persistent storage media comprises a solid state drive.

10. An electronic processing system, comprising:
a processor; and
a trusted execution environment coupled to the processor, wherein the trusted execution environment includes security code which when executed by the processor is to:
securely request information related to a change log from a storage system outside of the trusted execution environment;
securely receive information related to the change log from the storage system outside the trusted execution environment; and
determine the presence of any unauthorized changes to the storage system based on the information received from the storage system.

11. The electronic processing system of claim 10, wherein the security code is further to bypass an operating system storage stack to request and receive the information from the storage system.

12. The electronic processing system of claim 11, wherein the security code to bypass the operating system storage stack includes code to communicate over a sideband interface with the storage system.

13. The electronic processing system of claim 10, wherein the security code is further to request a current size of the change log from the storage system.

14. The electronic processing system of claim 10, wherein the security code is further to request a list of changed logical block addresses from the storage system.

15. The electronic processing system of claim 10, wherein the security code is further to request the storage system to clear a dirty bit in the change log.

16. The electronic processing system of claim 10, wherein the security code is further to perform a forensic analysis based on the information received from the storage system.

17. A method of monitoring a storage system, comprising:
sending a secure request from a trusted execution environment to a storage system outside of the trusted execution environment for information related to a change log;
securely receiving at the trusted execution environment the information related to the change log from the storage system outside the trusted execution environment; and
determining at the trusted execution environment a presence of any unauthorized changes to the storage system based on the information received from the storage system.

18. The method of claim 17, further comprising:
bypassing an operating system storage stack to request and receive the information from the storage system.

19. The method of claim 18, further comprising:
requesting the storage system to clear a dirty bit in the change log.

20. The method of claim 17, further comprising:
detecting a rootkit attack based on the information received from the storage system.

21. The method of claim 17, further comprising:
performing a malware analysis based on the information received from the storage system.

22. The method of claim 17, further comprising:
mapping changed logical block addresses to an operating system file system based on the information received from the storage system.

23. The method of claim 22, further comprising:
capturing runtime information about file system changes based on the information received from the storage system.

24. The method of claim 17, further comprising:
remediating any unauthorized changes to the storage system.
